(19) United States
(12) Patent Application Publication
(10) Pub. No.: US 2022/0198739 A1
(43) Pub. Date: Jun. 23, 2022

(54) PARALLELIZATION FOR RAYTRACING

(71) Applicant: Advanced Micro Devices, Inc., Santa Clara, CA (US)

(72) Inventors: Skyler Jonathon Saleh, San Diego, CA (US); Maxim V. Kazakov, San Diego, CA (US); Swapnil P. Sakharshete, San Diego, CA (US); Takahiro Harada, Santa Clara, CA (US); Vineet Goel, San Diego, CA (US)

(73) Assignee: Advanced Micro Devices, Inc., Santa Clara, CA (US)

(21) Appl. No.: 17/129,766

(22) Filed: Dec. 21, 2020

(51) Int. Cl. G06T 15/06; G06T 15/00

(52) U.S. Cl. CPC G06T 15/06; G06T 2210/21; G06T 15/005

(57) ABSTRACT

A technique for performing ray tracing operations is provided. The technique includes performing bounding volume hierarchy (“BVH”) traversal in multiple accelerated processing devices (“APDs”), utilizing bounding volume hierarchy data copies in memories local to the multiple APDs; rendering primitives determined to be intersected based on the BVH traversal, using geometry information and texture data spread across the memories local to the multiple APDs; and storing results of rendered primitives for a set of tiles assigned to the multiple APDs into tile buffers stored in APD memories local to the APDs.

### BACKGROUND

Ray tracing is a type of graphics rendering technique in which simulated rays of light are cast to test for object intersection and pixels are colored based on the result of the ray cast. Ray tracing is computationally more expensive than rasterization-based techniques, but produces more physically accurate results. Improvements in ray tracing operations are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to execution of processing tasks on the accelerated processing device of FIG. 1, according to an example;

FIG. 3 illustrates a ray tracing pipeline for rendering graphics using a ray tracing technique, according to an example;

FIG. 4 is an illustration of a bounding volume hierarchy, according to an example;

FIG. 5 illustrates aspects of a parallelization technique related to tiling a render target, according to an example;

FIG. 6 is a block diagram of a set of APDs configured to cooperate to render a scene using ray tracing, according to an example;

FIG. 7 is a block diagram illustrating connectivity between different APDs, according to an example; and

FIG. 8 is a flow diagram of a method for performing ray tracing operations, according to an example.

### DETAILED DESCRIPTION

A technique for performing ray tracing operations is provided. The technique includes performing bounding volume hierarchy (“BVH”) traversal in multiple accelerated processing devices (“APDs”), utilizing bounding volume hierarchy data copies in memories local to the multiple APDs; rendering primitives determined to be intersected based on the BVH traversal, using geometry information and texture data spread across the memories local to the multiple APDs; and storing results of rendered primitives for a set of tiles assigned to the multiple APDs into tile buffers stored in APD memories local to the APDs.

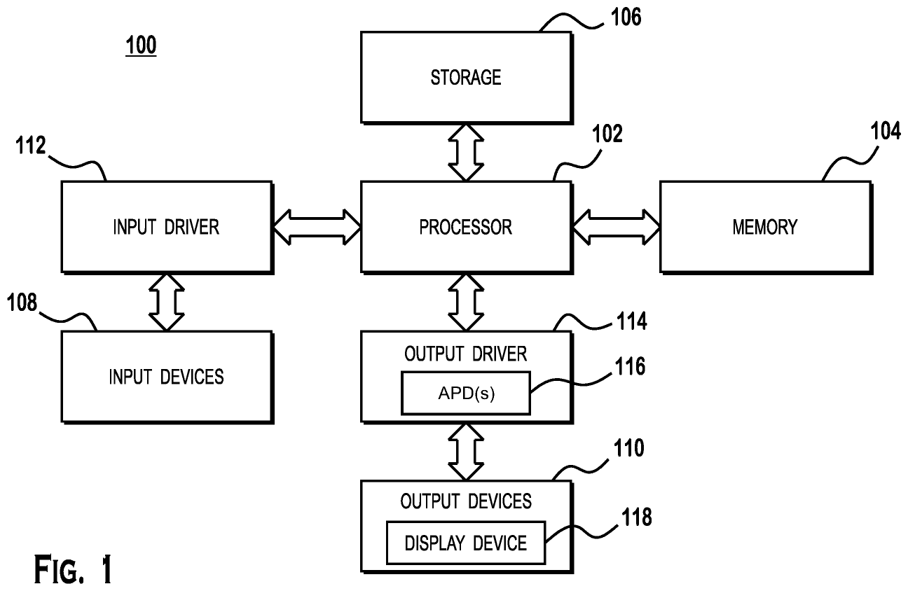

FIG. 1 is a block diagram of an example device 100 in which one or more features of the disclosure can be implemented. The device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also optionally includes an input driver 112 and an output driver 114. It is understood that the device 100 includes additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes multiple accelerated processing devices (“APD”) 116. In various examples, one or more of these APDs 116 are coupled to a display device 118, although implementations that do not include a display device are contemplated as well. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide (graphical) output to a display device 118. For example, it is contemplated that any processing system that performs processing tasks in accordance with a SIMD paradigm can be configured to perform the functionality described herein. Alternatively, it is contemplated that computing systems that do not perform processing tasks in accordance with a SIMD paradigm performs the functionality described herein.

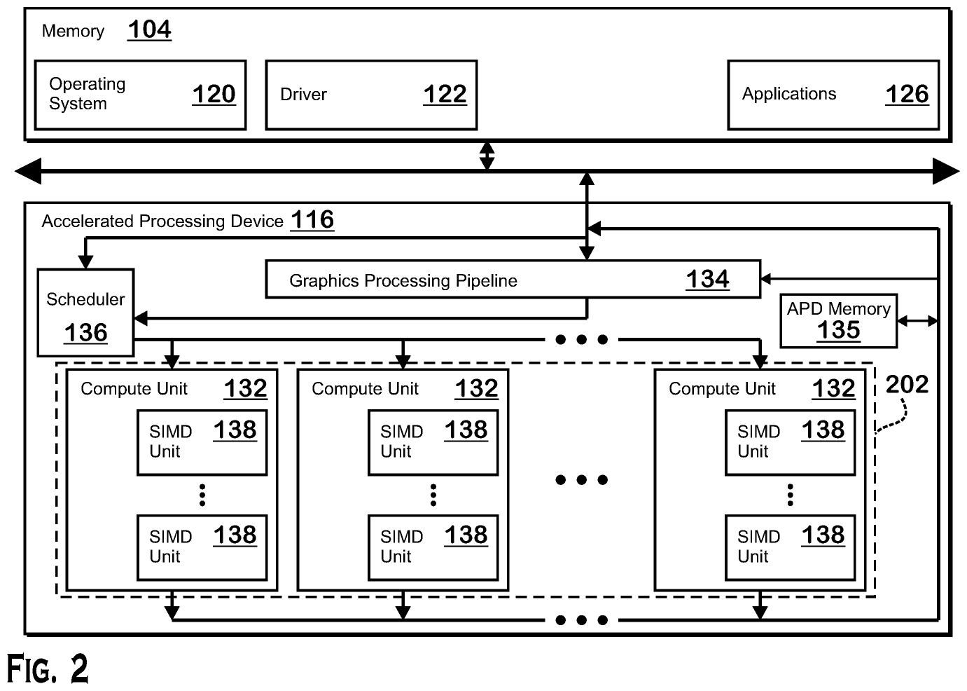

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some implementations, the driver 122 includes a just-in-time compiler that compiles programs for execution by processing components (such as the SIMD units 138 discussed in further detail below) of the APD 116. In other implementations, no just-in-time compiler is used to compile the programs, and a normal application compiler compiles shader programs for execution on the APD 116.

The APD 116 includes an APD memory 135. The APD memory 135 is considered “local” to the APD 116. Access by elements of the APD 116 to the APD memory 135 is done with lower latency than access by those elements to other memory such as an APD memory 135 of a different APD 116 or system memory 104. In other words, a memory access request sent by an element of an APD 116 to a local APD memory 135 completes in fewer clock cycles than a memory access request sent by the element of the APD 116 to an APD memory 135 of a different APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 (together, parallel processing units 202) that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The compute units 132 implement ray tracing, which is a technique that renders a 3D scene by testing for intersection between simulated light rays and objects in a scene. Much of the work involved in ray tracing is performed by programmable shader programs, executed on the SIMD units 138 in the compute units 132, as described in additional detail below.

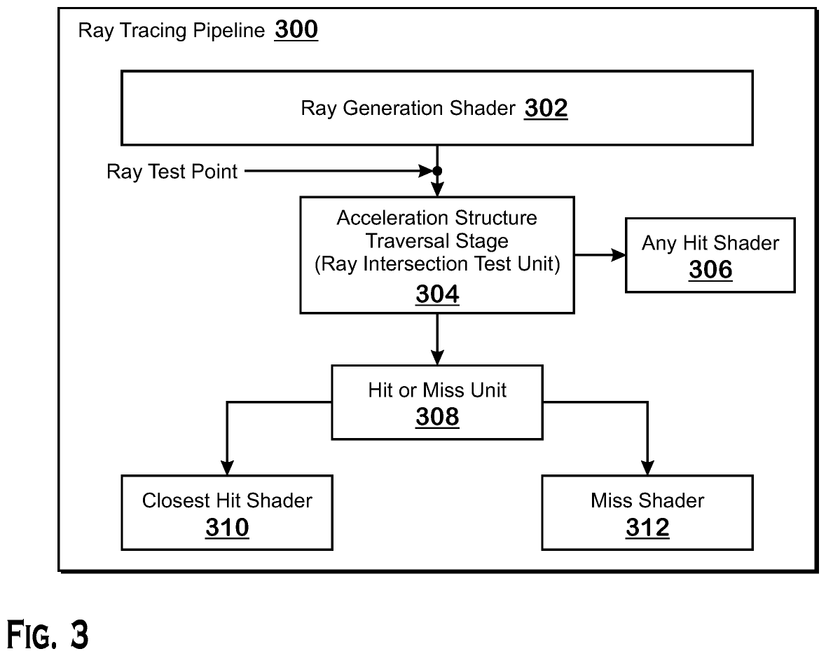

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used. It should be understood that, in various examples, to render a scene, the APD 116 accepts and executes commands and data from, for example, the processor 102, to perform a number of ray intersection tests and to execute appropriate shaders.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In an example bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent different axis aligned bounding boxes that cover different parts of the entire region. Each of those two children has two child nodes that represent axis aligned bounding boxes that subdivide the space of their parents, and so on. Leaf nodes represent a triangle or other primitive against which a ray test can be performed.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, and tests against leaf node primitives.

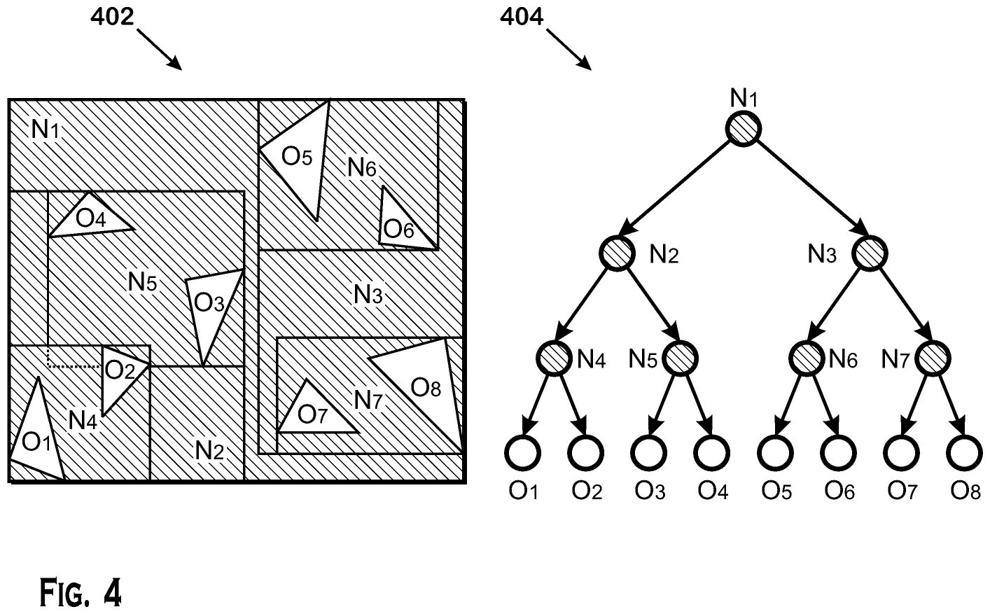

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “0” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails Instead of testing 8 triangle tests, two triangle tests (O₅ and O₆) and five box tests (N₁, N₂, N₃, N₆, and N₇) are performed.

As just stated, performing an intersection test for a ray involves traversing a bounding volume hierarchy 404. In general, traversing the bounding volume hierarchy 404 involves the ray intersection test unit 304 fetching data for box nodes and performing an intersection test for the ray against those nodes. If the test succeeds, the ray intersection test unit 304 fetches data for children of that box node and performs intersection for those nodes.

In some situations, fetching data for a node requires a fetch to memory (e.g., memory local to the APD 116 or system memory 104). It is possible for such a fetch to incur a relatively large amount of latency, such as thousands of APD processor clock cycles. Further, the bounding volume hierarchy 404 includes data dependencies, since the determination of whether to fetch data for a particular node is based on the results of an intersection test for a parent of that node. A strict depth-first traversal of the bounding volume hierarchy 404, which would have the benefit of requiring relatively lower number of intersection tests, has the drawback that such traversal is unable to hide memory latency by pipelining memory fetches for multiple nodes, due to the data dependencies. For this reason, the present disclosure presents a technique for parallelizing intersection tests by performing tests against multiple nodes of the same BVH for the same ray, concurrently.

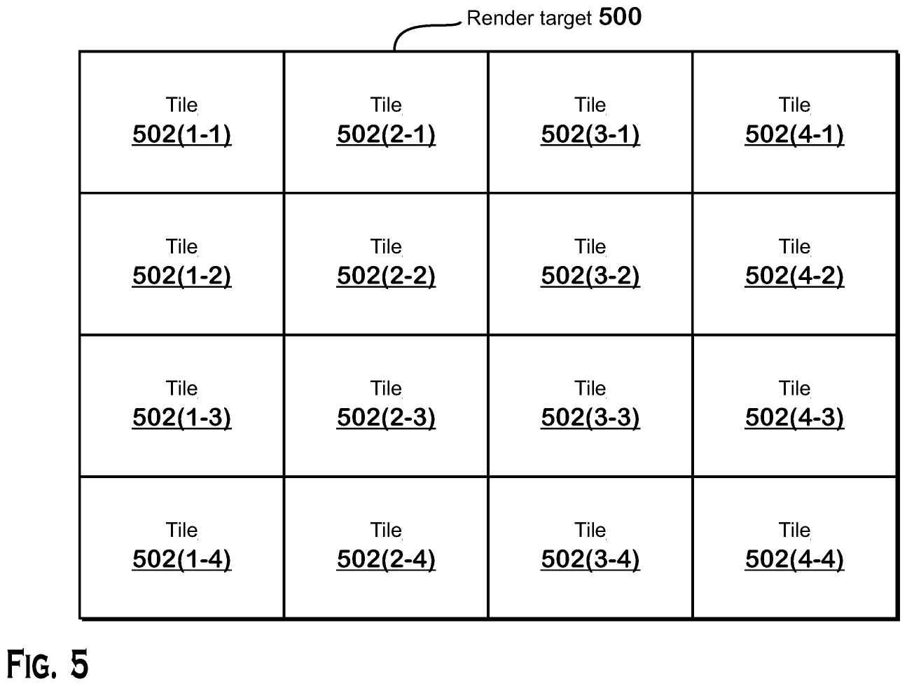

FIG. 5 illustrates aspects of a parallelization technique related to tiling a render target, according to an example. FIG. 5 illustrates a render target 500. The render target 500 represents a result of ray tracing operations. In examples, the render target 500 is a frame buffer with contents that are displayed to a display device 118, the render target 500 is an intermediate buffer storing pixel data for further processing, or the render target 500 is a buffer storing rendered pixel data for other purposes.

The render target 500 is divided into tiles 502. The tiles are mutually exclusive subsets of the pixels in the render target 500. To parallelize rendering of a frame, the tiles 502 are assigned to different APDs 116. The results (e.g., pixel color values) for a particular tile 502 are determined by the APD 116 assigned to that tile and not by any other APD 116. Thus the scene is parallelized by rendering different portions of the render target by different APDs 116.

In operation, an entity such as the driver 122 determines how to divide a render target 500 into tiles 502 and how to assign tiles 502 to APDs 116. In addition, the driver 122, which receives ray tracing requests from a client such as one or more applications 126, transmits ray tracing operations to the APDs 116 that cause the different APDs 116 to render the associated tiles 502. In an example, an application 126 requests that a scene, defined at least by a set of geometry, is rendered to a render target 500. In response, the driver 122 identifies which APDs 116 are to render which tiles 502. The driver 122 transmits commands to the participating APDs 116 to render the scene at for the respective tiles 502. The APDs 116 render the scene as requested.

In examples, rendering a scene for a tile 502 with ray tracing includes generating rays for the pixels of the tile 502 and performing ray tracing operations with those rays, as described, for example, with respect to FIG. 3. Performing these ray tracing operations is sometimes referred to herein as “casting a ray.” The rays originate at the camera, and intersect the pixels of the image. Rendering for the entire render target 500 would include casting rays through each pixel of the render target. However, rendering for each individual tile 502 involves casting rays through the pixels of that tile 502 and not through the pixels of other tiles. Thus rendering a scene for a tile 502 involves casting rays that intersect the pixels of the tile 502 but not for that intersects pixels of other tiles 502. Thus an entire render target 500 can be generated in parallel on different APDs 116 by rendering multiple different tiles 502 in parallel.

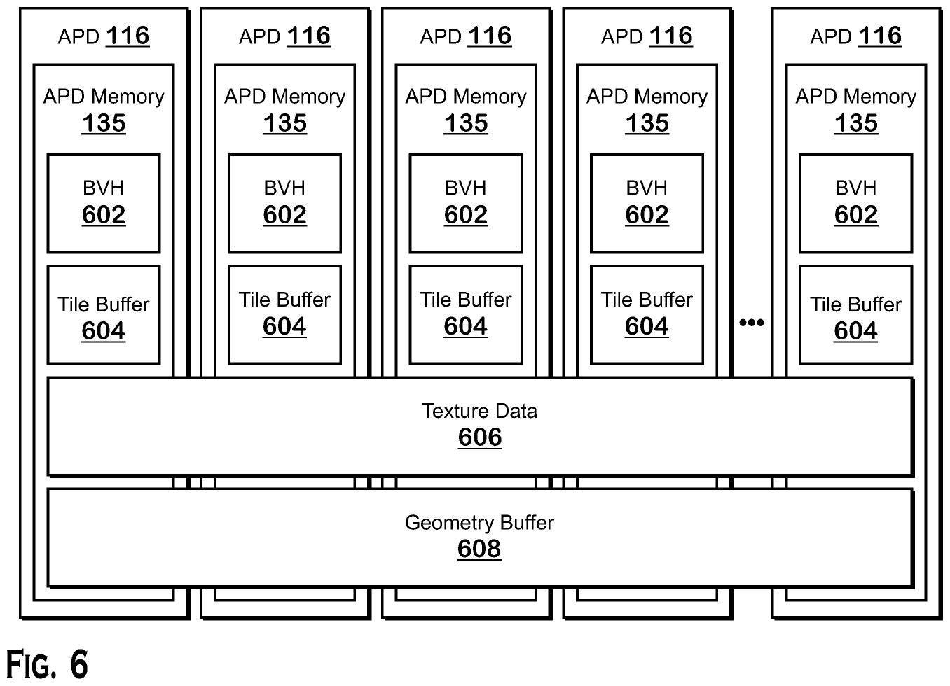

FIG. 6 is a block diagram of a set of APDs 116 configured to cooperate to render a scene using ray tracing, according to an example. FIG. 6 illustrates the APD memory 135 of the APDs 116. However, for clarity, other elements of the APDs 116, such as those elements illustrated in FIG. 2, are not shown in FIG. 6. It should be understood, however, that the elements of FIG. 2, and optionally other elements, are present in the APDs 116.

In operation, while rendering with ray tracing in a parallel manner as described elsewhere herein, the APDs 116 stores various data in the APD memories 135 of the different APDs 116. Specifically, the APDs 116 store bounding volume hierarchy data 602, tile buffer data 604, texture data 606, and geometry buffer data 608.

The APDs 116 store a copy of the bounding volume hierarchy data 602 for the scene being rendered. In some examples, the bounding volume hierarchy data 602 the is stored in each APD 116 is the same. In some examples, all APDs 116 store all of the bonding volume hierarchy data 602 needed to render a scene. In some examples, the APDs 116 store different bounding volume hierarchy data 602, but each APD 116 has no restriction regarding which bounding volume hierarchy data 602 is to be stored in an APD memory 135 of the APD 116. More specifically, in operation, it is possible for an APD 116 to “page in and out” portions of the BVH 602 if the APD memory 135 is not large enough to store all BVH data 602. In these examples, each APD 116 is permitted to store any of the BVH data 602 in APD memory 135. The bounding volume hierarchy data 602 is a mirrored resource. More specifically, each APD 116 stores its own independent version of the bounding volume hierarchy 602, which allows the APD 116 to access the BVH data 602 with lower latency as compared to data stored in the APD memory 135 of a different APD 116 or a different memory such as the memory 104. The BVH data 602 is not specifically tied to any portion of the render target 500, because the BVH data 602 represents geometry, which is in world space, rather than pixels in screen space. Thus, the BVH data 602 is not subdivided on a per-APD basis. However, because the BVH data 602 is accessed very frequently by the APDs 116 as the APDs 116 perform ray tracing operations, at least some, and in some instances, all, of the BVH data 602 is duplicated across APDs 116 so that each APD 116 has local access to the BVH data 602, to reduce latency of access to the BVH data 602.

The APDs 116 store a tile buffer 604. A tile buffer 604 is a buffer that stores the pixel results of ray tracing operations for the tiles 502 assigned to the APD 116 in which the tile buffer 604 is stored. In other words, an APD 116 stores the pixel results of tiles 502 assigned to that APD 116 into the tile buffer 604 stored in the APD memory 135 of that APD 116. In an example, the render target buffer—the buffer into which the pixel results of ray tracing are written—is within the tile buffer 604 of, and thus within the APD memory 135 of, the APD 116 generating those pixel results. Because frequency of access to the tile buffer 604 is high, the APDs 116 maintain independent tile buffers 604 storing tile buffer data for tiles 502 processed in the respective APD 116.

Texture data 606 represents textures used by the APDs 116 to determine pixel colors. In examples, an APD 116 spawns a ray for a pixel, detects that the ray intersects a triangle, and determines a color for the pixel by examining the texture associated with the intersected triangle.

The geometry data 608 stores attributes for primitives of the scene being rendered. In an example, the geometry data 608 includes one or more of vertex coordinates, vertex colors, texture coordinates for primitives, and other attributes. The geometry data 608 includes data for primitives of the entire scene.

The texture data 606 and geometry data 608 is spread throughout the APD memories 135 of the different APDs 116. More specifically, the texture data for the primitives of the scene is stored throughout the different APD memories 135. This “spreading” of texture data is in contrast with the mirroring or copying of the BVH data 602. In an example, a copy of all of the BVH data 602 for a scene is stored in each of the APD memories 135, but a subset of the texture data 606 is stored in each of the APD memories 135. The geometry data 608 is, similarly, spread throughout the APD memories 135. In some examples, a subset of the geometry data for the geometry of a scene is stored in each of the APD memories 135.

In some examples, which specific items of texture data 606 or geometry data 608 that are stored in a particular APD memory 135 is determined based on the addresses of those items. In an example, different memory pages of texture data 606 or geometry data 608 are stored in different APD memory 135. It should be understood that a memory page is a consecutive “chunk” of memory, where all addresses within that chunk share a page number, and where the page number is a portion of a memory address. In an example, each increment of the page number is stored in a different APD memory 135. For example, page 1000 is stored in a first APD memory 135, page 1001 is stored in a second APD memory 135, and so on, with in a cyclical pattern (e.g., first APD memory 135 is assigned page 1000, 1008, 1016, and so on, where there are eight APDs 116). In another example, the pattern is such that multiple consecutive page numbers are assigned to each APD memory 135, but still in round robin manner. In an example, a first two (or four or eight) pages are assigned to a first APD 116, a second two pages are assigned to a second APD 116, and so on. It should be understood that the techniques described herein are not limited to the specific techniques disclosed for dividing the texture data 606 and geometry data 608, and that any technically feasible technique could be used. The texture data 606 and geometry data 608 is divided between the APD memories 135 in a manner that attempts to spread accesses to the different APD memories 135 evenly. Dividing these items by page number means that any particular access to a texture or geometry data is generally expected to access a random one of the APD memories 135. Spreading out traffic across the different APD memories 135 means that the entire system is not limited by the bandwidth to any particular APD memory 135. In other words, this type of spreading of the traffic helps prevent overload any particular APD memory 135.

It should be understood that in use, while any particular APD 116 is performing ray tracing operations, such APD 116 accesses the various data described in the various different APD memories 135 as needed. In an example, an APD 116 receives a request to render a particular tile. The APD 116 spawns rays for the pixels of that tile and performs ray tracing operations for those rays. The APD 116 accesses the local BVH copy in the BVH data 602 to perform the intersection tests. For example, the APD 116 traverses the BVH based on the BVH data 602 to identify primitive hits or misses. The APD 116 executes shaders for hits, utilizing geometry data to execute those shaders. The APD 116 stores results for the shader executions into the buffer 604. For a frame, when all APDs 116 have rendered all tiles, it is possible for an entity such as the driver 122 to collect the data of the tiles into a frame buffer for subsequent use or into an intermediate buffer. Alternatively or additionally, an entity such as display driver internal to one of the APDs 116 or an independent display driver reads the data from each tile buffer 604 out to a screen.

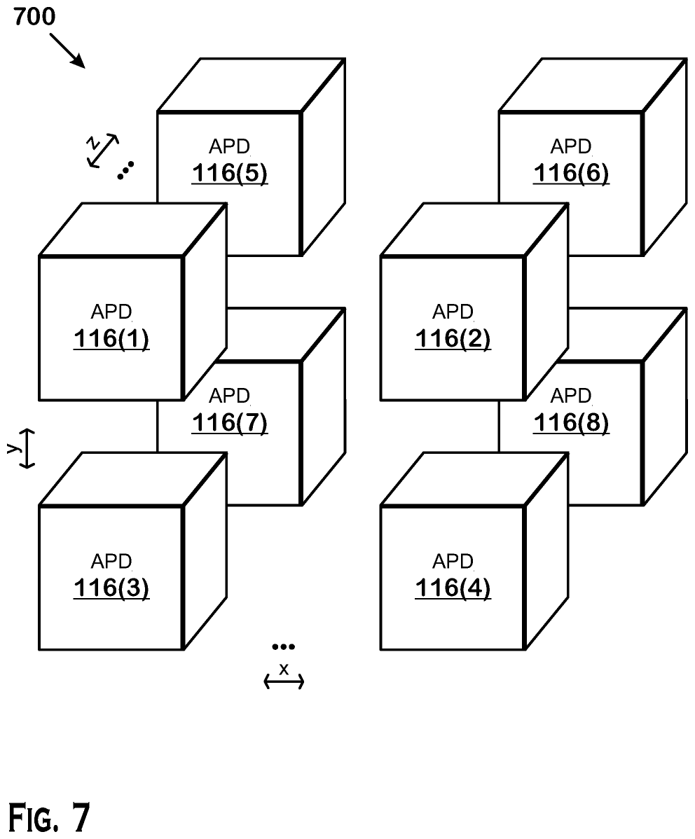

FIG. 7 is a block diagram illustrating connectivity between different APDs 116, according to an example. In the example configuration 700, the APDs 116 are organized in a cube topology. In the cube topology, each APD 116 has connectivity to immediate neighbors in each of three dimensions. More specifically, the cube topology has x, y, and z dimensions. Each APD 116 has a coordinate in each dimension. These coordinates increment in the x, y, and z dimension with different APDs 116 along those dimensions. An APD 116 is an immediate neighbor of another APD 116 in the situation that two of the three coordinate values are the same and the last coordinate value is one different. In an example, APDs 116 at coordinates 1, 1, 1, and 1, 1, 2 are immediate neighbors.

Using a cube topology provides good latency performance for memory transactions from one APD 116 to the APD memory 135 of a different APD 116. More specifically, a cube topology results in a relatively low number of “hops” between APDs 116, where a “hop” refers to a communication interaction between two different APDs 116. In an example, an APD 116 having coordinates 1, 1, 1 performs a memory transaction with an APD 116 having coordinates 2, 2, 1. In this case, in an example, the APD 116 at coordinates 1, 1, 1, communicates with an APD 116 at coordinates 2, 1, 1, which communicates with the APD 116 at coordinates 2, 2, 1—a total of two hops. It should be understood that other connectivities could be used and that a cube topology is only an example.

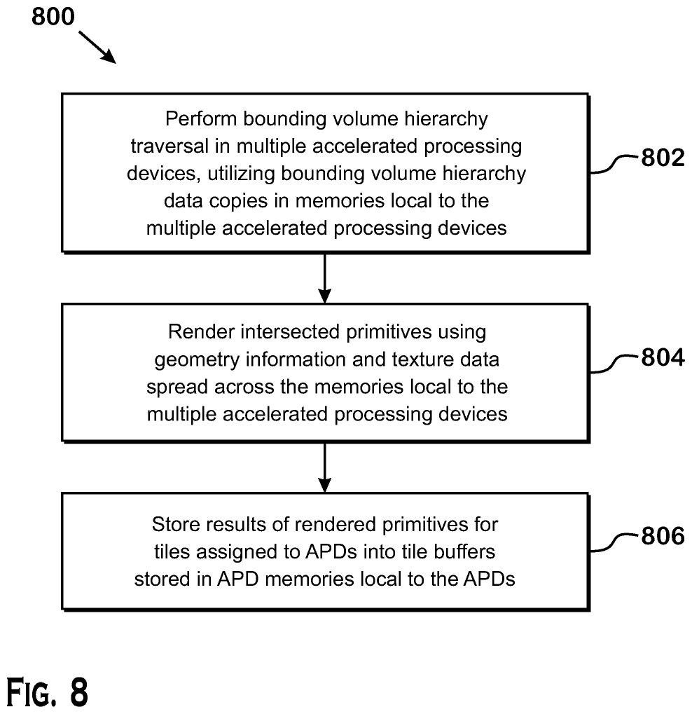

FIG. 8 is a flow diagram of a method 800 for performing ray tracing operations, according to an example. Although described with respect to the system of FIGS. 1-7, those of skill in the art will recognize that any system, configured to perform the steps of the method 800 in any technically feasible order, falls within the scope of the present disclosure.

The method 800 begins at step 802, where a set of APDs 116 perform bounding volume hierarchy traversal, utilizing bounding volume hierarchy data 602 copies stored in APD memories 135 that are local to the multiple accelerated processing devices. The BVH copies 602 are described elsewhere herein and are local copies of the BVH for a scene. The local copies provide low latency access to these bounding volume hierarchy. It should be understood that step 802 does not require any timing relationship for the various APDs 116 that perform the bounding volume hierarchy traversal. For example, it is not required, though it is permitted, for the different APDs 116 to perform the traversal at the same time or in overlapping time periods.

At step 804, the APDs 116 render primitives that are intersected, according to the BVH traversal, using geometry information stored in a geometry buffer 608 across the APDs 116, and texture data 606 spread across the memories 135 local to the APDs 116. Again, these operations do not have to be performed at the same time in the different APDs 116, although some or all may be.

At step 806, the APDs 116 store the results of the rendered primitives into tile buffers 604 in APD memories 135 local to the APDs 116 generating those results. As described elsewhere herein, each APD 116 is assigned one or more tiles and performs operations to render for those one or more tiles 502. The tile buffer 604 for each APD 116 stores rendering results for the tiles 502 assigned to those APDs 116.

Note that although the present disclosure describes triangles as being in the leaf nodes of the bounding volume hierarchy, any other geometric shape could alternatively be used in the leaf nodes. In such instances, compressed triangle blocks include two or more such primitives that share at least one vertex.

Each of the units illustrated in the figures represent hardware circuitry configured to perform the operations described herein, software configured to perform the operations described herein, or a combination of software and hardware configured to perform the steps described herein. For example, the ray tracing pipeline 300, ray generation shader 302, any hit shader 306, hit or miss unit 308, miss shader 312, closest hit shader 310, and acceleration structure traversal stage 304 are implemented fully in hardware, fully in software executing on processing units (such as compute units 132), or as a combination thereof. In some examples, the acceleration structure traversal stage 304 is partially implemented as hardware and partially as software. In some examples, the portion of the acceleration structure traversal stage 304 that traverses the bounding volume hierarchy is software executing on a processor and the portion of the acceleration structure traversal stage 304 that performs the ray-box intersection tests and ray-triangle intersection tests is implemented in hardware.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for performing ray tracing operations, the method comprising:
performing bounding volume hierarchy (“BVH”) traversal in multiple accelerated processing devices (“APDs”), utilizing bounding volume hierarchy data copies in memories local to the multiple APDs, wherein a first APD of the multiple APDs accesses bounding volume hierarchy data in a memory local to the first APD but not in a memory local to any other APD;
rendering primitives determined to be intersected based on the BVH traversal, using geometry information, wherein a first APD of the multiple APDs accesses a first portion of the geometry information from a first memory local to the APD and accesses a second portion of the geometry information from a second memory not local to the APD and local to a second APD of the multiple APDs; and
storing results of rendered primitives for a set of tiles assigned to the multiple APDs into tile buffers stored in APD memories local to the APDs.

2. The method of claim 1, wherein each bounding volume hierarchy data copy includes identical data.

3. The method of claim 1, wherein the BVH traversal includes:
testing a ray for intersection with non-leaf nodes of the BVH; and
eliminating from consideration descendants of non-leaf nodes that do not intersect with the ray.

4. The method of claim 1, wherein, for one APD of the multiple accelerated processing devices, rendering the primitives includes evaluating rays that intersect with a tile of the set of tiles, wherein the tile is assigned to the one APD.

5. The method of claim 4, wherein evaluating the rays that intersect the tiles includes casting rays through pixels of the tile, identifying primitives intersected by the casted rays, and executing one or more shader programs to determine colors for the casted rays.

6. The method of claim 4, wherein evaluating the rays include identifying colors for pixels of the tile based on texture data.

7. The method of claim 1, wherein each tile buffer stores data for one or more tiles assigned to an APD in which the tile buffer resides.

8. The method of claim 1, wherein page numbers of memory pages of the geometry information and memory pages of texture data determines which APD the memory pages are stored in.

9. The method of claim 1, wherein rendering the primitives includes using texture data and includes receiving at least a portion of the texture data and the geometry data at a first APD of the multiple APDs, from one or more other APDs of the multiple APDs, connected in a cube topology.

10. A system for performing ray tracing operations, the method comprising:
a plurality of accelerated processing devices (“APDs”), each including a local memory, configured to:
perform bounding volume hierarchy (“BVH”) traversal, utilizing bounding volume hierarchy data copies in the local memories, wherein a first APD of the plurality of APDs accesses bounding volume hierarchy data in a memory local to the first APD but not in a memory local to any other APD;
render primitives determined to be intersected based on the BVH traversal, using geometry information, wherein a first APD of the plurality of APDs accesses a first portion of the geometry information from a first local memory local to the APD and accesses a second portion of the geometry information from a second local memory not local to the APD and local to a second APD of the plurality APDs; and
store results of rendered primitives for a set of tiles assigned to the multiple APDs into tile buffers stored in the local memories.

11. The system of claim 10, wherein each bounding volume hierarchy data copy includes identical data.

12. The system of claim 10, wherein the BVH traversal includes:
testing a ray for intersection with non-leaf nodes of the BVH; and
eliminating from consideration descendants of non-leaf nodes that do not intersect with the ray.

13. The system of claim 10, wherein, for one APD of the multiple accelerated processing devices, rendering the primitives includes evaluating rays that intersect with a tile of the set of tiles, wherein the tile is assigned to the one APD.

14. The system of claim 13, wherein evaluating the rays that intersect the tiles includes casting rays through pixels of the tile, identifying primitives intersected by the casted rays, and executing one or more shader programs to determine colors for the casted rays.

15. The system of claim 13, wherein evaluating the rays include identifying colors for pixels of the tile based on texture data.

16. The system of claim 10, wherein each tile buffer stores data for one or more tiles assigned to an APD in which the tile buffer resides.

17. The system of claim 10, wherein page numbers of memory pages of the geometry information and memory pages of texture data determines which APD the memory pages are stored in.

18. The system of claim 10, wherein rendering the primitives includes using texture data and includes receiving at least a portion of the texture data and the geometry data at a first APD of the multiple APDs, from one or more other APDs of the multiple APDs, connected in a cube topology.

19. An accelerated processing device (“APD”), comprising:
a processor; and
a local memory,
wherein the processor is configured to:
perform bounding volume hierarchy (“BVH”) traversal, utilizing bounding volume hierarchy a data copy in the local memory, wherein the processor accesses bounding volume hierarchy data in the local memory but not in a memory local to any other APD;
render primitives determined to be intersected based on the BVH traversal, using geometry information, wherein the processor accesses a first portion of the geometry information from the local memory and accesses a second portion of the geometry information from a second local memory not local to the APD and local to a second APD of the multiple APDs; and
store results of rendered primitives for a set of tiles assigned to the APD into a tile buffer stored in the local memory.

20. The APD of claim 19, wherein each bounding volume hierarchy data copy includes identical data.
